(19) United States
(12) Patent Application Publication
(10) Pub. No.: US 2025/0190769 A1
(43) Pub. Date: Jun. 12, 2025

(54) INTERFACE FOR GENERATING DOCUMENTS WITH GENERATIVE ARTIFICIAL INTELLIGENCE

(71) Applicant: Microsoft Technology Licensing, LLC, Redmond, WA (US)

(72) Inventors: Philipp STEINACHER, Berlin (DE); Michael Gerhard DIETZ, Berlin (DE)

(73) Assignee: Microsoft Technology Licensing, LLC, Redmond, WA (US)

(21) Appl. No.: 18/534,936

(22) Filed: Dec. 11, 2023

(51) Int. Cl. G06N 3/0475

(52) U.S. Cl. CPC G06N 3/0475

(57) ABSTRACT

A data processing system includes: a processor; and a memory comprising programming instructions for execution by the processor alone or in combination with other processors, to implement a service to generate a work as specified by a user. The service includes: a service-side component of a User Interface (UI) to receive user input about the work from the user, the user input including an initial prospective description of the work that the user intends to generate using the system and a set of parameters for the work; a prompt generator to generate prompts for a Large Language Model (LLM) based on the user input to generate both an outline for the work and a proposed version of the work, the prompt generator further to generate additional prompts to the LLM to update either the outline or the proposed version of the work based a user editing of the other of the outline or the proposed version of the work; and an Application Programming Interface to deliver prompts to the LLM and receive responses from the LLM for presentation in the UI.

### BACKGROUND

Prior to computers and word processors, the technology of document production involved the use of pen and paper. The user had to mentally compose what content to communicate and then write the words by hand. If the user decided to rephrase or reorganize the communication, this may have required discarding the work to that point and starting over with a fresh sheet of paper. As the technology of document production has evolved, many of these technical problems have been solved. For example, with a computerized word processor, a user can rephrase or reorganize the wording of a document very readily and without discarding other parts of the work that are satisfactory. The user can also readily include other elements in the document such as pictures or figures. The user can also format and reformat the document for a desired appearance.

However, some of the technical problems of document production remain. For example, the user still must mentally determine what ideas to communicate, what wording to use, how to organize the thoughts, etc. These aspects of producing a document may now be the most time-consuming for the user. Accordingly, additional technical solutions to these technical problems are needed.

### SUMMARY

In one general aspect, the following description presents a data processing system includes: a processor; and a memory comprising programming instructions for execution by the processor alone or in combination with other processors, to implement a service to generate a work as specified by a user. The service includes: a service-side component of a User Interface (UI) to receive user input about the work from the user, the user input including an initial prospective description of the work that the user intends to generate using the system and a set of parameters for the work; a prompt generator to generate prompts for a generative artificial intelligence (GAI), such as a Large Language Model (LLM), based on the user input to generate both an outline for the work and a proposed version of the work, the prompt generator further to generate additional prompts to the LLM to update either the outline or the proposed version of the work based a user editing of the other of the outline or the proposed version of the work so that the proposed version of the work and the outline are synchronized as the user interacts with either the proposed version of the work or the outline; and an Application Programming Interface to deliver prompts to the LLM and receive responses from the LLM for presentation in the UI.

In another general aspect, the following description presents a device having: a processor, and a memory storing executable instructions which, when executed by the processor alone or in combination with other processors, causes the processor, alone or in combination with other processors, to perform the following functions: with a User Interface (UI), receive user input about the work from the user, the user input including an initial prospective description of the work that the user intends to generate using the system and a set of parameters for the work; and with a prompt generator, generate prompts for a Large Language Model (LLM) based on the user input to generate both an outline for the work and a proposed version of the work, the prompt generator further to generate additional prompts to the LLM to update either the outline or the proposed version of the work based a user editing of the other of the outline or the proposed version of the work.

In another general aspect, the following description presents a method of generating a work for a user, the method comprising: with a User Interface (UI) receiving a description from a user describing the work that the user wants to generate; with the UI, receiving user input selecting a setting from among multiple options for each of a number of parameters for the work; with a prompt generator, generating a prompt to a Large Language Model (LLM), the prompt instructing the LLM to generate an outline for the work based on the description and the options selected for each of the parameters; with the prompt generator, generating another prompt to the LLM instructing the LLM to generate a proposed version of the work based on the outline; with the UI, receiving user edits to either the outline or the proposed version of the work; and in response to user edits to either the outline or the proposed version of the work, with the prompt generator, generating an additional prompt to the LLM instructing the LLM to revise the other of the outline or proposed version of the work based on the user edits.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A-IF depict a series of images of a user interface that is part of an example system in which aspects of the principles of this description may be implemented.

FIG. 2 depicts an example flow to be implemented with the user interface and system described herein.

FIG. 3 depicts the components of the example system according to the principles described herein.

FIGS. 4A and 4B are flowcharts illustrating an example method according to the principles described herein.

FIG. 5 depicts another aspect of a user interface that is part of the example system in which aspects of the principles of this description may be implemented.

FIG. 6 is another flowchart illustrating an example method according to the principles described herein.

FIG. 7 is a block diagram illustrating an example software architecture, various portions of which may be used in conjunction with various hardware architectures herein described.

FIG. 8A is a block diagram illustrating components of an example machine configured to read instructions from a machine-readable medium and perform any of the features described herein.

FIG. 8B is a block diagram depicting an example architecture for a generative Artificial Intelligence as used in the examples and techniques described herein.

### DETAILED DESCRIPTION

As noted above, some of the technical problems of document production remain. For example, the user still must mentally determine what ideas to communicate, what wording to use, how to organize the thoughts, etc. These aspects of producing a document may now be the most time-consuming for the user. Accordingly, additional technical solutions to these technical problems are needed.

Accordingly, the following description relates to assistance and an improved user interaction model that leverages a Generative Artificial Intelligence (GAI) such as Large Language Models (LLMs), e.g., GPT4, and specific signals that may include goal, tone, voice, audience, and output type as well as other graph data in an interactive way using a split screen or similar multiple canvas approach. The technical problem being addressed is that the task of creating a well-structured document outline and notes, and then inferring a full written document from the outline, is manual and difficult for users. Further, the task is not well supported by an interaction model that forces the user to generate queries to the LLM. Accordingly, the technical solution provided herein includes, in one aspect, a system architecture that allows for the LLM to analyze signals that may include the goal, tone, voice, audience and document type, suggest a document structure based on the analysis, and then generate a full document based on the structure, signals, and interactive input from the user. Another aspect includes a canonical user experience for generating a full document in an interactive way using the outline as a basis for the interaction. The interaction is done in a way that document content is synchronized in real time with the outline as changes are made to either. In the user interface, the outline and the generated document are displayed in separate canvases.

As used herein and in the appended claims, the term GAI will refer broadly to any generative artificial intelligence that can receive a user prompt and generate content in response to, and based on, the user prompt. Examples of a GAI include Large Language Models (LLMs), both bloom models and generative pretrained transformers (GPTs), and others

As used herein and in the appended claims, the term “work” will refer broadly to any content that a user wants to generate. In various examples, a work, as defined herein, could be a document, a slide deck, programming code, a code analysis, a message, a proposal, a presentation, an article, an editorial or any other type of content a user wants to generate. Also, as used herein, the term Large Language Model (LLM) will refer broadly to any generative artificial intelligence that provides the functionality of responding to a user prompt with generated content, even if that AI is of a generative model different from an LLM.

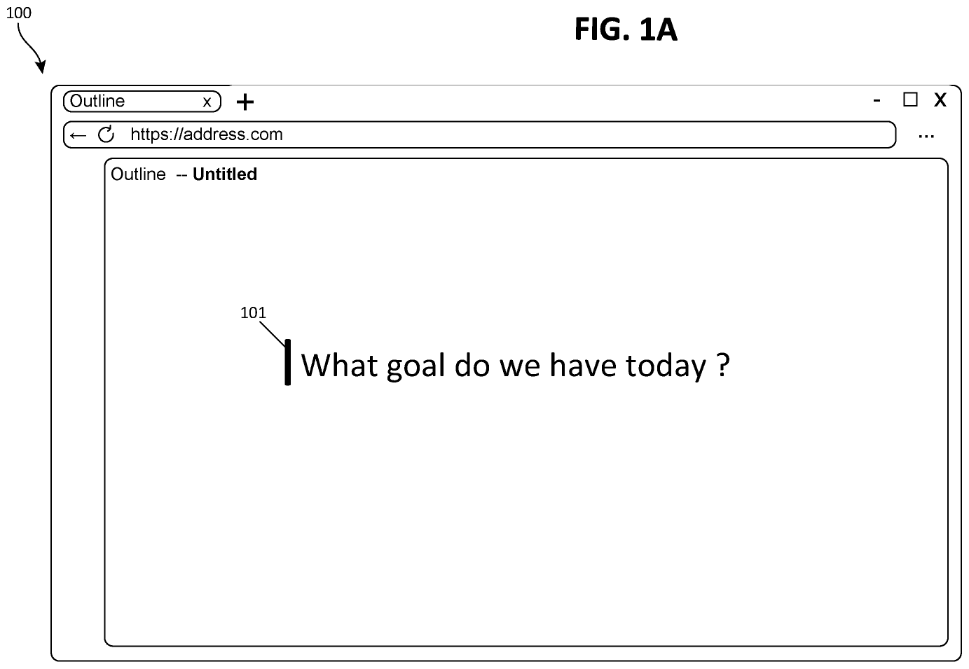

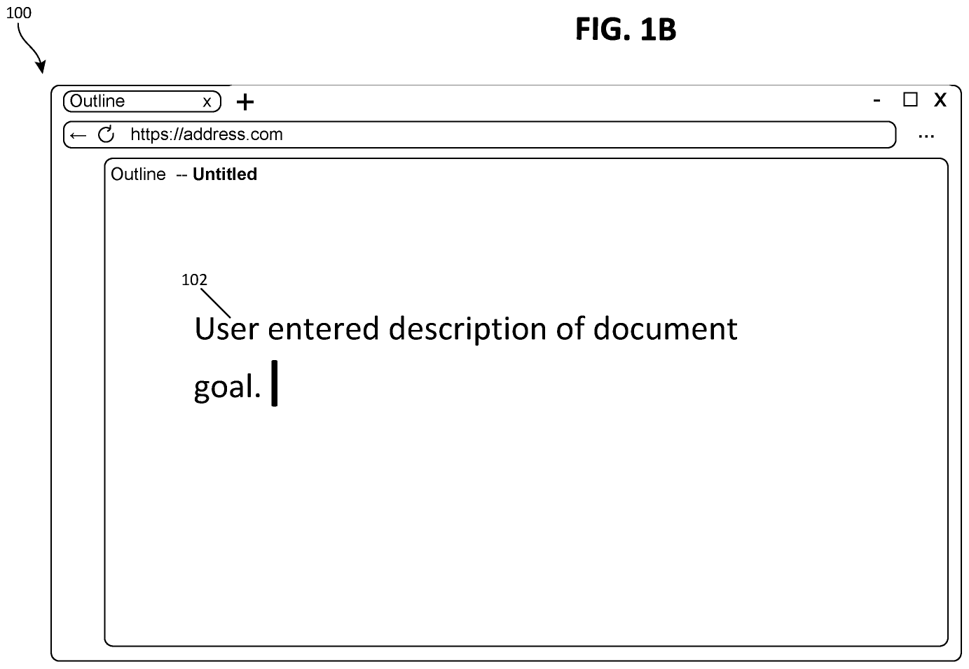

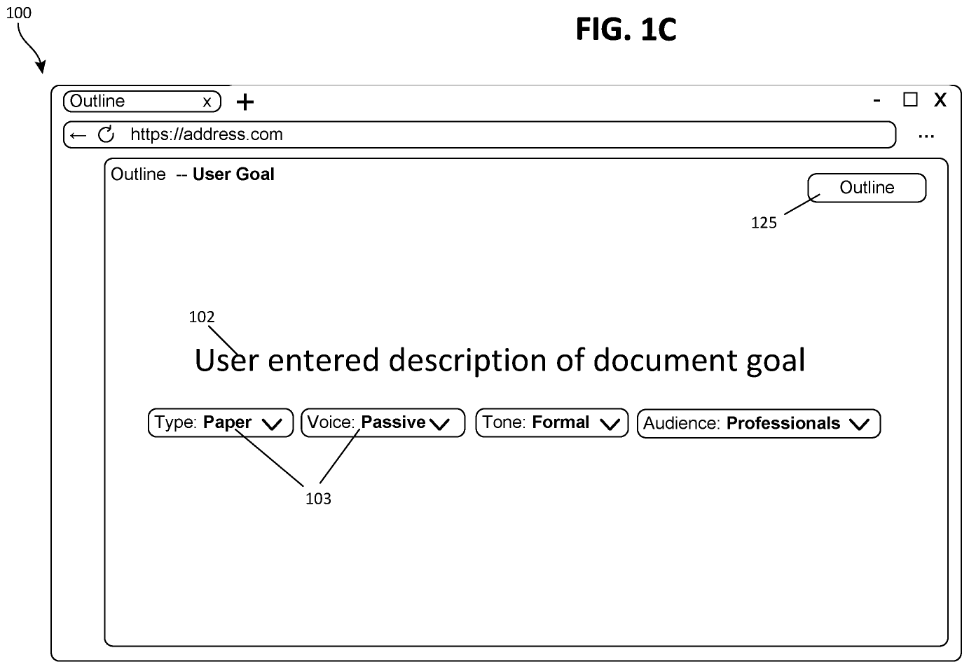

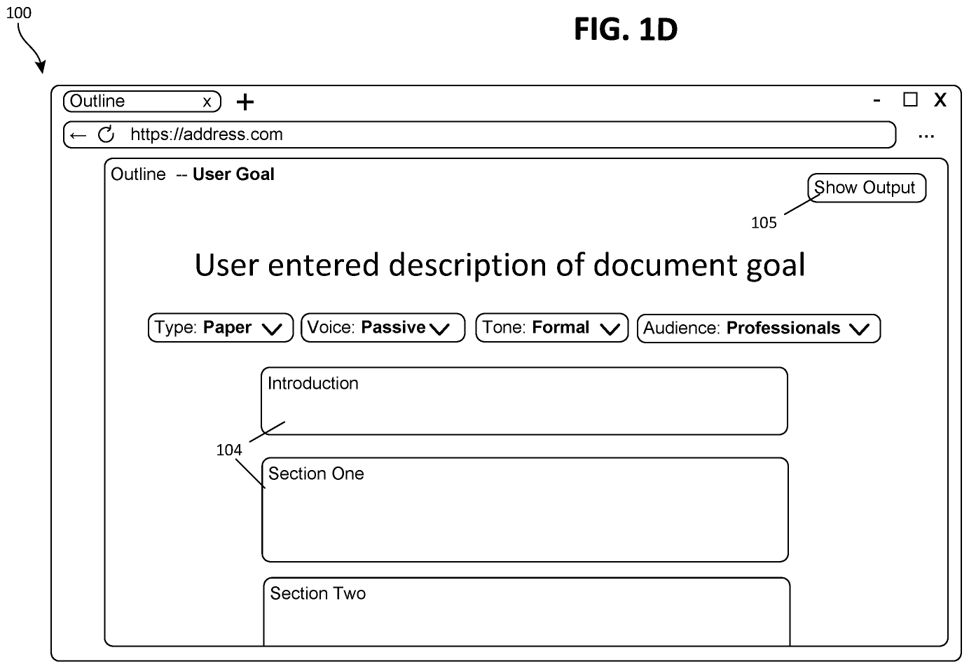

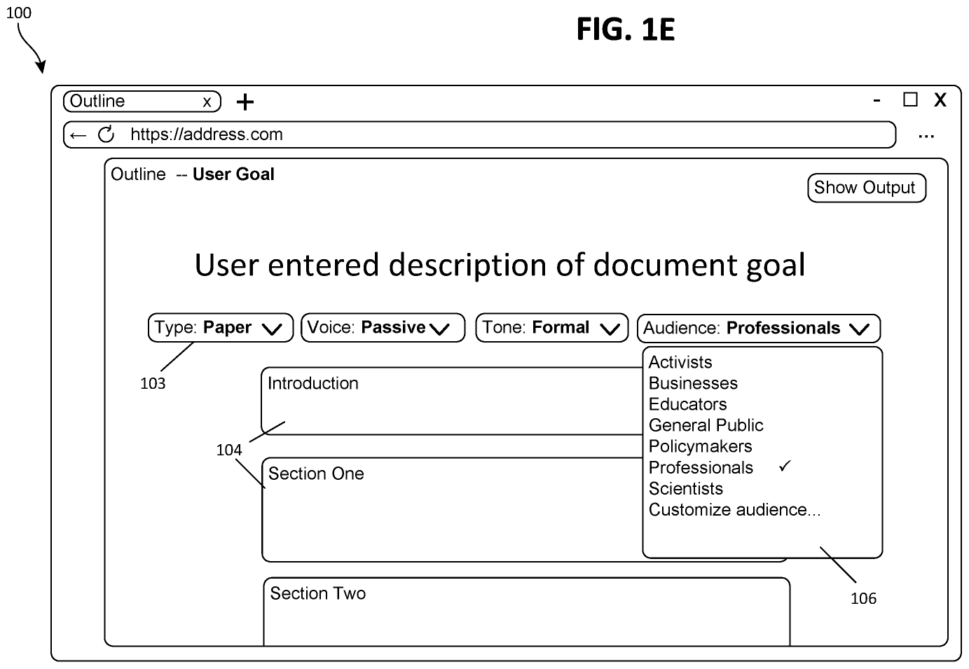

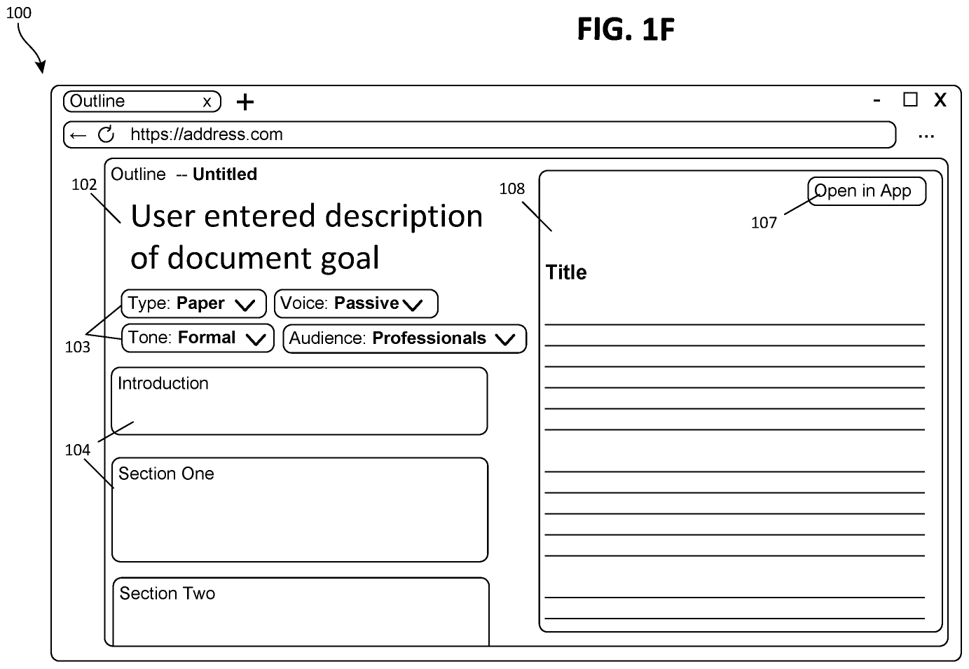

FIGS. 1A-IF depict a series of images of a user interface that is part of an example system in which aspects of the principles of this description may be implemented. Referring to FIG. 1A, a user interface 100 is accessed when a user needs to compose a new document or work. This could be a paper, article, report, computer code or any other written work. In the example of FIG. 1A, the user interface 100 could be part of a local application, a cloud-based application or services (such as SaaS), a browser or other platform. As shown in FIG. 1A, the service begins by prompting the user to input a description of the work the user is seeking to generate. For example, the user interface may display a cursor 101 with the question: “What goal do we have today?”

In FIG. 1B, the user has typed a description of the document or work that the user wishes to create. This is an initial, prospective description of the document or work that has not yet been created but which the user desires, prospectively, to generate. In various examples, this could be “an article about the urgency of climate change,” “convince my boss to give me a travel budget,” “inventors pitch deck for my startup,” or “code for our landing page,” etc. The user is able to freely type any description for the work to be generated. As in these examples, the description is generally given in natural language. In other examples, the user's stated goal could include writing a message to a particular person, colleague or group using a particular messaging application, generating a slide deck on a particular subject, generating a document for use in a particular word processing application, generating computer code, performing an analysis of computer code or performing a data science analysis. For data science and analysis, the user may specify an application, such as Jupyter®, with which the analysis is to be performed. For computer code, the user may specify an integrated development environment, such as Visual Studio.

Upon receiving the description of the work to be created, the system will generate a corresponding prompt to a Large Language Model (LLM). The prompt will include the description of the work to be created, as entered by the user, with a request to generate a list of parameters and options for each parameter that corresponds to the description. The prompt can be formatted in natural language. In one example, the user entered description is: “An opinion piece on why we urgently have to act on the climate crisis.” Accordingly, the prompt to the LLM might be “We are drafting ‘An opinion piece on why we urgently have to act on the climate crisis.’ Generate a list of parameters that would affect how that document is composed and a number of options for each such parameter.”

This prompt is then submitted to an LLM, for example, a Generative Pre-Trained Transformer (GPT) or other LLM. The LLM will return a response listing parameters that would affect how the document is composed and options for each. For example:

### Tone and Style:

Option 1: Urgent and alarmist
Option 2: Calm and persuasive
Option 3: Inspirational and motivational

### Audience:

Option 1: General public
Option 2: Policymakers and government officials
Option 3: Business leaders and corporations

### Level of Detail:

Option 1: High-level overview for a broad audience
Option 2: In-depth analysis with scientific data for a more specialized audience
Option 3: Balanced mix of both for a wider impact

### Emotional Appeal:

Option 1: Appeal to fear and urgency
Option 2: Appeal to empathy and shared responsibility
Option 3: Appeal to hope and the potential for positive change

### Call to Action:

Option 1: Encourage individual lifestyle changes (e.g., reducing carbon footprint)
Option 2: Advocate for policy changes and government action
Option 3: Emphasize the role of businesses in sustainable practices

### Use of Statistics and Data:

Option 1: Include prominent statistics to highlight the severity of the crisis
Option 2: Provide case studies and real-world examples
Option 3: Combine both for a well-rounded argument
   Global vs. Local Focus:
Option 1: Emphasize the global impact of climate change
Option 2: Highlight local consequences and actions
Option 3: Balance both global and local perspectives
   Engagement with Skepticism:
Option 1: Acknowledge and address common climate change skepticism
Option 2: Focus on presenting overwhelming scientific consensus
Option 3: Use anecdotal evidence to make the issue relatable

### Historical Context:

Option 1: Discuss the historical development of the climate crisis
Option 2: Highlight past missed opportunities for action
Option 3: Draw parallels with successful environmental movements

### Visual Elements:

Option 1: Include graphs and charts for data visualization
Option 2: Feature impactful images to evoke emotion
Option 3: Combine both visuals and text for a multimedia approach

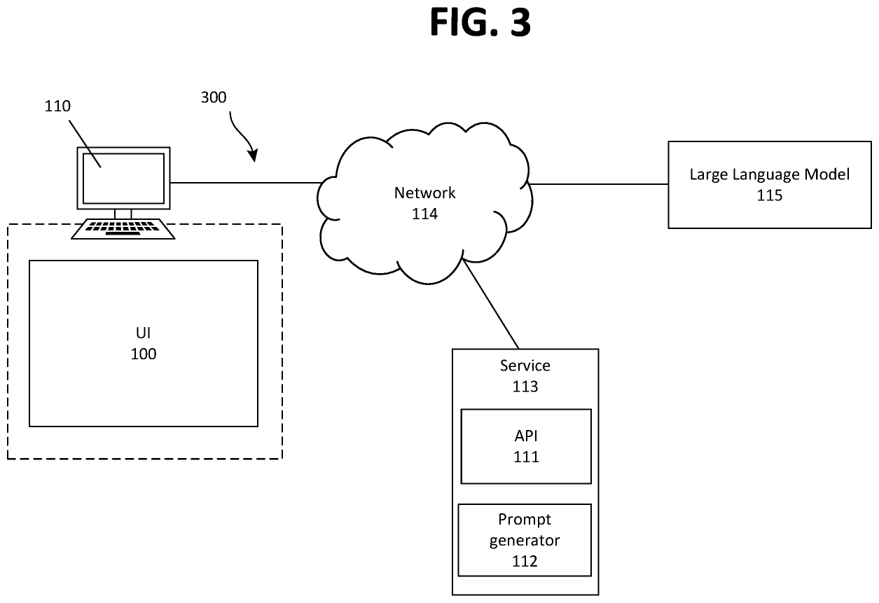

With this response from the LLM, the user interface is updated as shown in FIG. 1C. Specifically, the user interface will continue to display the description 102 that the user has entered for the document goal. The user interface 100 will also provide a number of drop-down menus 103 or other UI elements that display the parameters returned by the LLM. Each drop-down menu will correspond to one of the parameters returned by the LLM and will include the options from the LLM as the options of that menu. From the example above, a first drop-down menu may be to specify Tone and Style and may provide the three options listed above from which the user can make a selection. Not every parameter returned by the LLM is necessarily presented to the user. For example, the “type” of the document or work may be clear from the description the user has entered. Accordingly, “type” would not need to be a parameter, in such a case, that the user is further asked to specify. The service (113, FIG. 3) can, for example, include a listing of words that identify a “type” of the work to be generated. If the user description includes any of these words, the service may then exclude “type” from being a parameter with options that is presented to the user.

In other examples, the user's objective may be to have the LLM or other generative Artificial Intelligence write computer code. In such a case, the parameters offered would reflect that project. For example, one such parameter might be the language in which the code is to be written. In another example, if the user's goal is a data science analysis, the parameters might include the type of analysis or an application, such as a Jupyter® notebook, where the analysis will be managed. If the user's goal is computer code analysis, another parameter may be the data source of the code to analyze.

In an alternative implementation, the user interface may have a set list of parameters and corresponding options for the drop-down menu. In this alternative, there need not be any call to the LLM to define the parameters from which the user will make selections. For example, the set of parameters offered may consist of “Type,” “Voice,” “Tone” and “Audience,” as shown in FIG. 1C. However, allowing the LLM to suggest parameters based on each specific user description of the goal may allow later prompts to the LLM to be more specific to the user's context and to generate a more refined resulting document.

After the user has input selections for the available parameters, the system will generate another prompt for the LLM using that user input and the previously entered information. In the example of FIG. 1C, a button 125 may be displayed that the user can actuate when all the parameter options have been set. Alternatively, the system can automatically proceed with generating a prompt when the user has entered a selection for each parameter or when the user selects or changes any one of the parameters. In any of these cases, the new prompt might state: “We are drafting ‘An opinion piece on why we urgently have to act on the climate crisis.’ Generate notes to support this document and organize the notes into sections beginning with an introduction. The document will have the following parameters: type: paper; voice: passive; tone: formal; and audience: professional.” This prompt may be structured differently based on a number of templates or scripts depending on a type of the work to be produced. For example, if the user is producing a landing page analysis, pitch deck or landing page code, the prompt is structured accordingly.

FIG. 1D illustrates the user interface being updated to display the sections of notes 104 returned from the prompt to the LLM. For example, each section 104 may include a bulleted list of the ideas to be expressed or facts to be noted in a corresponding section of the work being generated. In some cases, the prompt to the LLM may specify that each section is to include a bulleted list of the ideas to be expressed or facts to be noted in a corresponding section of the work being generated. In other examples, if the user is generating computer code, the sections shown in FIG. 1D would each correspond to a different function of the code. Once the notes are output, the user is then able to edit the notes 104. For example, the user may add ideas or facts to a section, may delete notes proposed by the LLM, may reorganize the notes within a section or the sections themselves, etc. There is no restriction on the editing the user may perform on the proposed notes 104.

By generating these notes or outline, the prompts for the LLM are tuned in such a way to help the LLM focus on what the user actually wants and avoids having the LLM go off topic. In some examples, the user may include links to other documents or materials in the outline, for example, by using a Universal Resource Locator (URL) or other link. In this case, any such referenced document or material can be accessed and added to the prompt to the LLM to further guide the response of the LLM in the direction the user intends.

As shown in FIG. 1D, the user interface 100 now also includes a button 105, e.g., “Show Output.” When this button 105 is activated, perhaps after the user has edited the notes to his or her satisfaction, another prompt to the LLM is generated. This prompt is for the LLM to generate the document or work that the user is generating based on all of the input received and generated to this point. For example, the prompt can include an instruction to the LLM to produce a document based on and according to the user's original description, where the prompt also includes all the notes 104 with the revisions by the user, if any, as a guide to the LLM generating the desired work. This prompt to the LLM can also include all the parameter settings entered previously as additional guides to the LLM in drafting the target work. In an example, this prompt might be structured as follows: “Generate ‘An opinion piece on why we urgently have to act on the climate crisis’ using the following notes <append notes> and the following parameters <append parameters>.” In response, the LLM will generate the document or work the user is trying to produce with the strong guidance of the notes (with or without user edits) and the desired parameters.

FIG. 1E illustrates the user interface 100 at a point after the notes 104 have been generated. As also shown in FIG. 1E, the user can make further adjustments to the parameters 103 in addition to editing the notes 104. In the example of FIG. 1E, the drop-down menu 106 for the parameter “audience” is open and lists a number of possible audiences for whom the piece might be written. If the user changes a parameter setting, the system will generate a new prompt to the LLM that requests a rewrite or update of the notes 104 based on the newly entered parameter setting. For example, the new prompt can include all the prior information, i.e., the user's description, the original parameters, the original notes, the changed parameter and a request that the original notes be rewritten to account for the changed parameter.

As also shown in FIG. 1E, the drop-down menu 106 includes an option for “customize audience.” If the user selects this option, the user interface 100 will accept user input specifying an audience that is not in the offered list. This user input then becomes one of the parameter settings included in the prompts to the LLM as described herein. The LLM is equally able to accommodate a user specified audience that is not from the offered list as the audience specifications in the list. Any of the parameters and drop-down menus can include an option for the user to input a setting that is then included in the LLM prompts. This gives the user additional flexibility in generating the desired document.

In FIG. 1F, the user interface 100 is divided into two panels. On the left, the information generated previously is displayed, including the user's description 102 of the work being generated, the parameter controls 103 and the notes 104. On the right, the document or work 108 generated by the LLM using the user description, parameters and notes is displayed. The user interface 100 also include a button 107 for “open in app.” If activated, this button 107 causes the document 108 to be opened in a different application, for example, a word processor, slide presentation application, code editor, or other application corresponding to the type of work the document 108 represents.

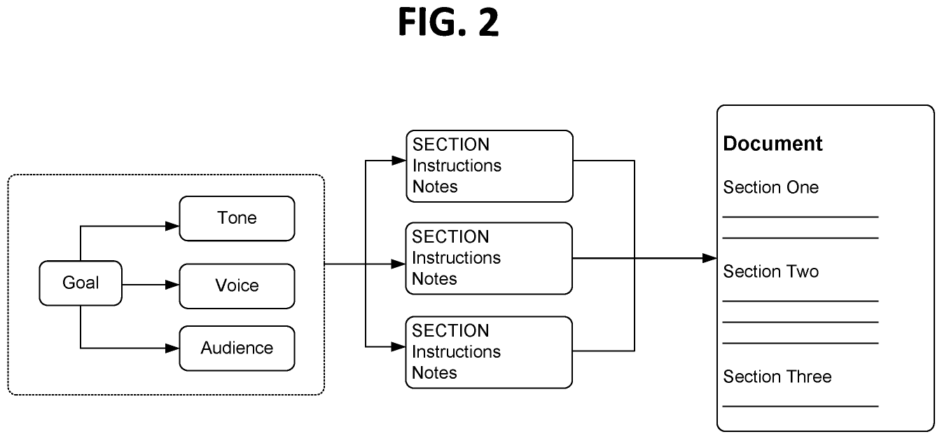

FIG. 2 depicts an example flow to be implemented with the user interface and system described herein. Consistent with the description above of FIGS. 1A-IF, FIG. 2 illustrates the following. The flow begins with the user specifying a goal, i.e., a description of the document or work that the user wants to produce. The user then also specifies a number of parameters for the work, such as Tone, Voice and Audience, as shown in FIG. 2. As described above, these parameter categories can be suggested by the LLM in response to an appropriately structured prompt or could be stock parameters always offered based on a type of work to be produced.

From the goal statement and the parameters, the LLM is prompted and provides a set of notes for the work to be generated. These notes are divided into sections and may include instructions as to how a corresponding section of the document is to be generated as well as notes, such as ideas or facts to be covered. In some examples, the notes are generated by the LLM based on the goal and parameter settings. The instructions, if any, can be instructions the user has entered into the user interface 100 describing how a particular section is to be written. For example, these instructions may be to write the corresponding section with a particular logical organization or with a parameter different from those generally specified for the rest of the document. Any instructions the user would like to add can be entered in the user interface 100 and then incorporated in subsequent prompts to the LLM along with the rest of the section organization.

Finally, as shown in FIG. 2, all the preceding input is utilized to produce the desired document. As described above, this is done by submitting a prompt to an LLM to produce the document.

FIG. 3 depicts the components of the example system 300 according to the principles described herein. As shown in FIG. 3, a user terminal 110 is provided with the user interface 100, as described above. The user terminal 110 may be a computer device on which the user can generate a document or work using the user interface 100 and service described above. For example, the user terminal 110 may be a desktop, laptop or tablet computer, a smartphone, personal digital assistant or other computer device. The user terminal 110 will include a processor or processing resources and a memory storing the programming executed by the processor.

As further shown in FIG. 3, the user terminal 110 includes a network interface with a computer network 114. Via this network, the user terminal 110 accesses a service 113 that provides the functionality described above in FIGS. 1A-IF. Specifically, the service 113 may support the user interface 100, such as through a local agent or via a browser on the user terminal 110. The service 113 receives all of the user input to the interface 100, as described above, for example, the user's description of the work to be generated, the user's settings for any parameters presented and any user edits to the notes or a proposed work returned by the LLM. The service 113 may be incorporated into an application or applications running locally on the user terminal 110. Alternatively, as shown in FIG. 3, the service 113 may be hosted on a server, virtual machine or other platform that is accessible via the network 114 to the user terminal 110. In such an example, the service 113 will incorporate underlying hardware including a processor and memory storing programming for the processor.

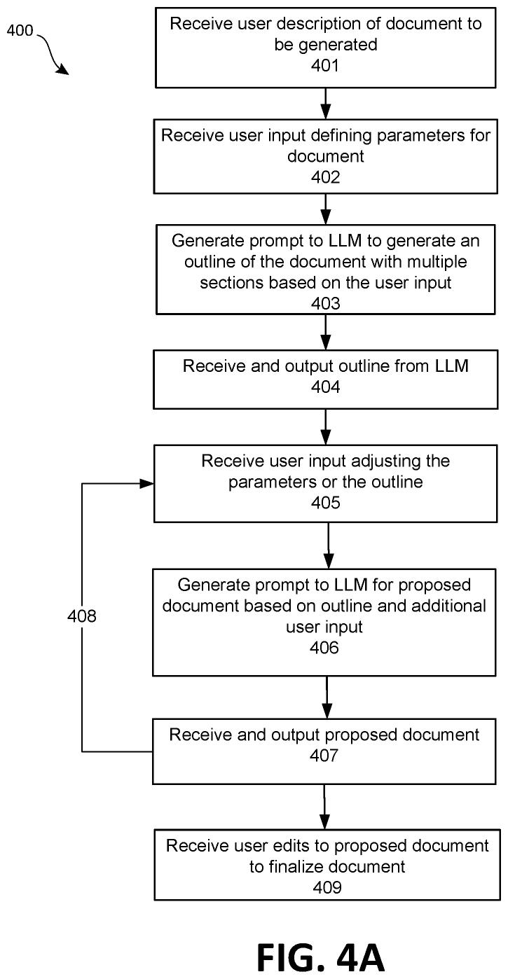

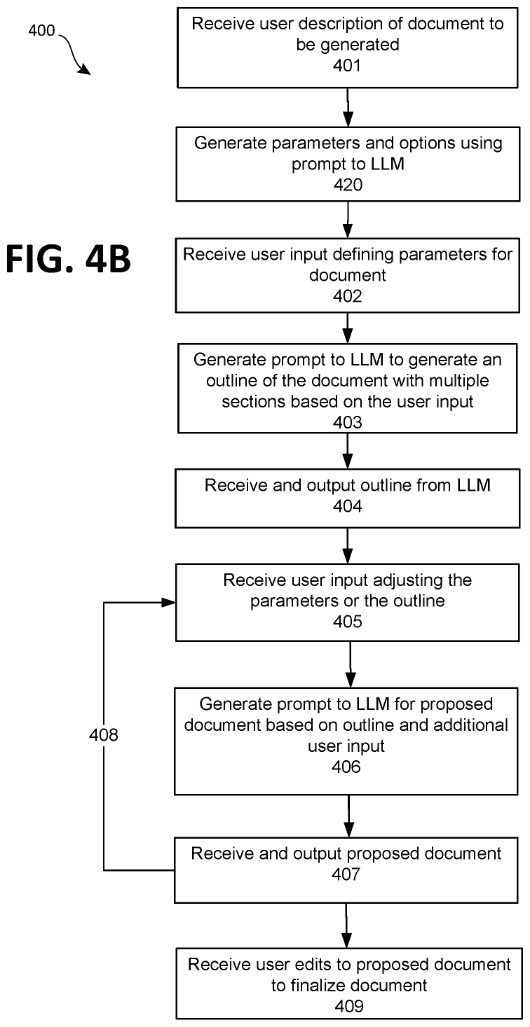

As shown in FIG. 3, with an Application Programming Interface (API) 111 and a prompt generator 112, the service 113 generates each of the various prompts described above for the LLM 115. The prompt generator 112 refers to, for example, a program application or applet with the underlying processing resources, wherein the prompt generator 112 detects inputs, as described herein, and responds by outputting a prompt to a Large Language Model or other Artificial Intelligence that is structured and provokes the LLM to respond as described herein. The service 113 submits the prompts to the LLM 115 via the network 114, receives the results and provides the output through the user interface 100 using the API 111, all as described above in reference to FIGS. 1A-IF and the flowchart of FIGS. 4A and 4B, described immediately below.

FIG. 4A is a flowchart illustrating an example method according to the principles described herein. As shown in FIG. 4A, and consistent with the explanation above of FIGS. 1A-IF, the method 400 begins with receiving a user description 401 of the document or the work to be generated. Next, further user input is received 402 specifying parameter settings for the document to be generated.

With this input, the method generates a prompt 403 to the LLM. This prompt requests the LLM to generate an outline or notes for the document with multiple sections based on the user input, as described above. This outline is received from the LLM and output 404 through the user interface. At this point, the user can operate the user interface to make changes to the parameter settings and/or to the notes of the outline received from the LLM. If any such user input is made, that input is received 405 and used to generate a new prompt to the LLM.

This prompt 406 now instructs the LLM to produce the document that the user is trying to generate based on the outline and previously received inputs. This prompt is submitted to the LLM and a proposed draft of the document is received 407 and output with the user interface. Arrow 408 indicates that the user then has the option to further adjust the parameter settings and/or the outline for the document. In response, a new prompt is generated 406 and a revised version of the document is generated and output 407. The user can also directly edit 409 the proposed document so as to finalize the document as desired.

FIG. 4B illustrates the method 400, as described above, but with additional flow regarding the parameters that are set to initially define the document. The process begins, again, with the user inputting a description of the goal, document or work to be generated 401. With this information, the method generates a prompt for the LLM, as described above, asking the LLM to generate a list of parameters relating to the user's objective with options under each of the parameters 420. In this version of the method, the parameters and options generated by the LLM are then presented to the user. For example, the parameters and options are presented as a series of drop-down menus. Each of these menus can include an open option for the user to enter a setting that is not among the options listed. The method then receives the user input 402 selecting a setting for each of the parameters available. The method then proceeds as described above with regard to FIG. 4A.

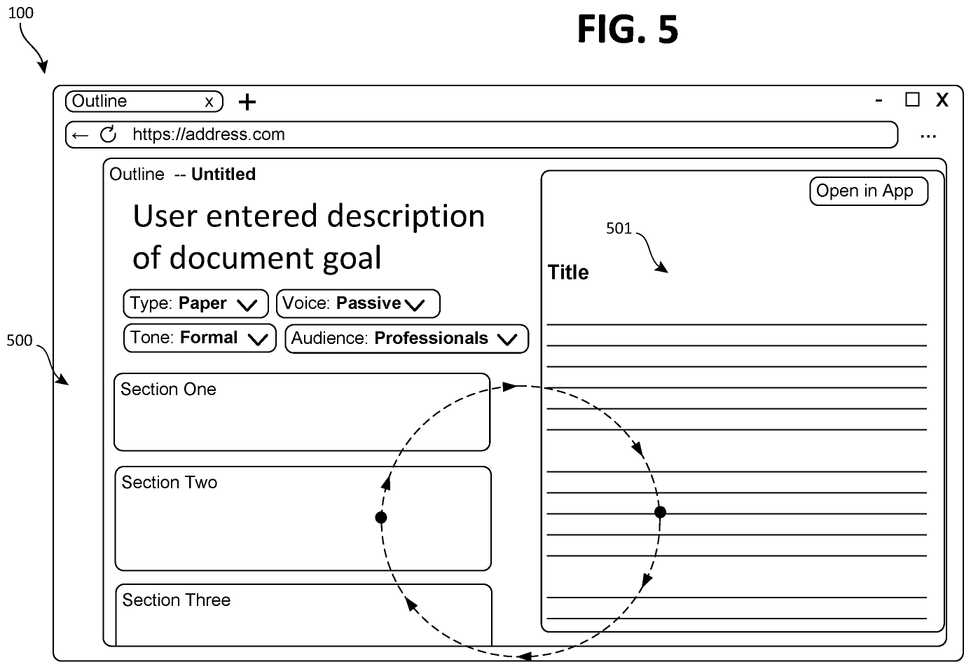

FIG. 5 depicts another aspect of a user interface that is part of the example system in which aspects of the principles of this description may be implemented. As shown in FIG. 5 and as described above, each section of the outline corresponds to a section of the document or other work being produced. In the user interface 100 of FIG. 5, both the outline 500 and the corresponding document 501 are displayed in a side-by-side arrangement.

As indicated by the arrowed circle, a user can the edit either document 501 on the right or the outline 500 on the left. In the example of FIG. 5, the user is editing either Section Two of the outline 500 or the corresponding paragraph of the document 501. When the user makes an edit to either the outline or the document, a prompt is generated to the LLM to make a corresponding update in the other of the outline or the document. Specifically, if the user enters an edit to the document 501, for example, in the second paragraph, a prompt is prepared to the LLM. This prompt may include the text of the outline 500 and the document 501 prior to the edit, the content of the edit and an instruction to the LLM to revise the outline 500 consistent with the edit to the document.

On the other hand, if the user makes an edit to the outline, for example, Section Two, a similar prompt is prepared for the LLM requesting the LLM to update the document 501 based on the edit made to the outline. This prompt may similarly include the text of the outline and the document prior to the edit, the content of the edit and an instruction to the LLM to revise the document 501 consistent with the edit to the outline 500.

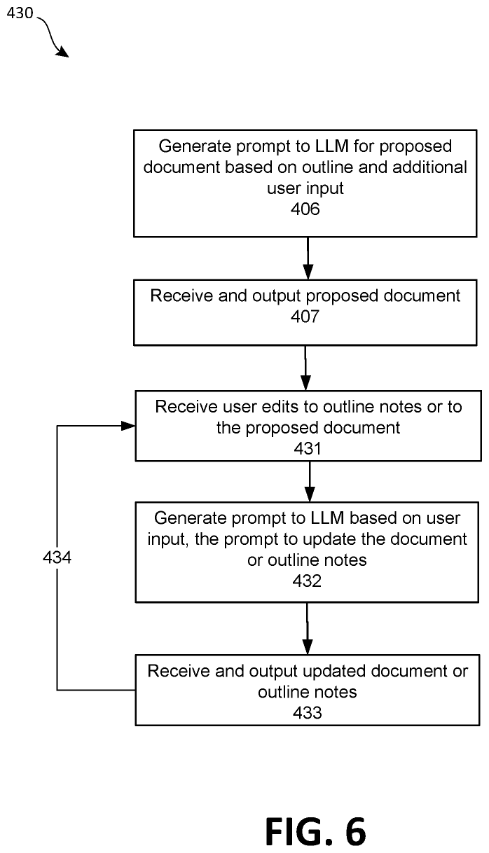

FIG. 6 is another flowchart illustrating an example method 430 according to FIG. 5 and the principles described herein. As shown in FIG. 6, the method 430 is similar to the previous methods described in that an LLM is prompted 406 to generate a work for the user based on an outline and other user input previously received. The LLM generates the work based on the prompt. The work or document is then received 407 and output in the user interface, as described above.

At this point, the user can edit either the outline notes or the document itself. In either case, this user input is received 431 and results in the new prompt to the LLM based on the user's edits. As described above, the prompt will instruct the LLM to update the notes or the document based on the user's editing of the other, i.e., if the user edits the notes, the LLM is prompted to update the document accordingly, or, if the user edits the document, the LLM is prompted to update the notes or outline accordingly. In this way, the notes and document are kept synchronized relative to the intent and updates entered by the user.

In the user interface 100 described herein, text formatting may also be used as a tool to allow the user to further guide the prompts that are generated to the LLM. For example, if the user bolds or highlights a phrase in the outline or the document, the prompt generator will detect this text formatting and will include in the prompt that the LLM is to emphasize or weight the subject of the bolded or highlighted text in preparing its response. Similarly, if a user strikes through text in the outline or document, the prompt generator will accordingly include in the prompt an instruction for the LLM to ignore that material in preparing its response. In this case, a user may want to see how the output of the LLM is changed by removing the struck through material while leaving the material in the outline, for example, to be reconsidered or reintroduced later.

The user interface 100 may also have additional features to assist the user. For example, if the user hovers the mouse or cursor over a particular section of the outline, the corresponding portion of the document may be highlighted to show the correspondence between the outline and document. This feature may also work in reverse if the user is hovering over a portion of the document and wants to find the corresponding section of the outline.

As the user is editing in the user interface, whether in the outline or the document, user changes can be stored in a log. This log is then used in subsequent prompts to the LLM. For example, if the user actively shortened a section of the text or outline, a future prompt may include an instruction that this section is not to be expanded in the next iteration. In this way, the system fine-tunes the prompts to the LLM based on the user activity to that point.

The prompt generator, as described herein, can prompt the LLM to revise only a section effected by a user edit to reduce processing time. However, the entire document is typically included in the prompt for context to the LLM.

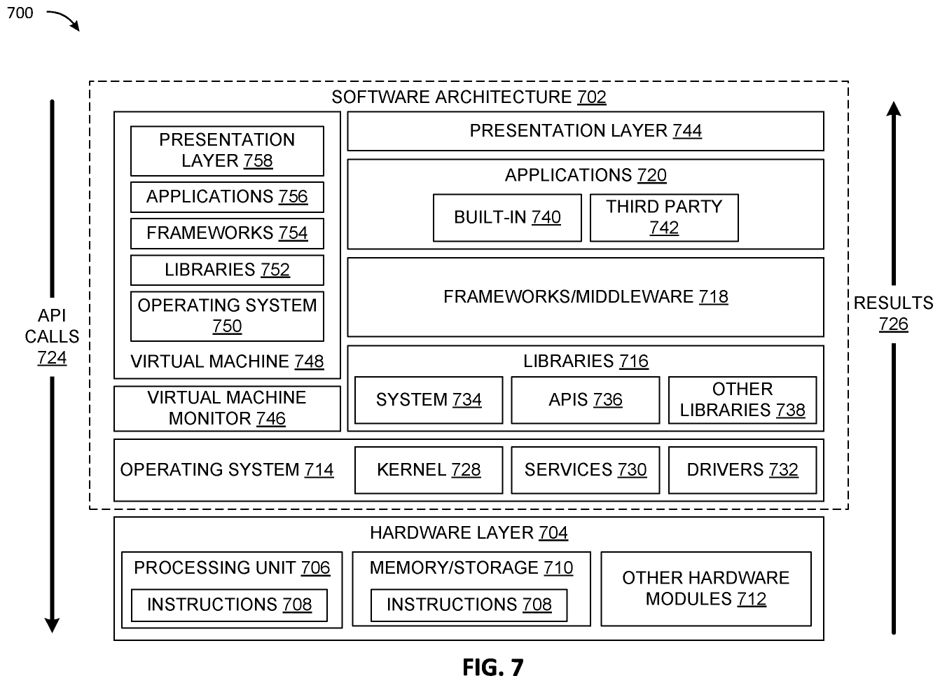

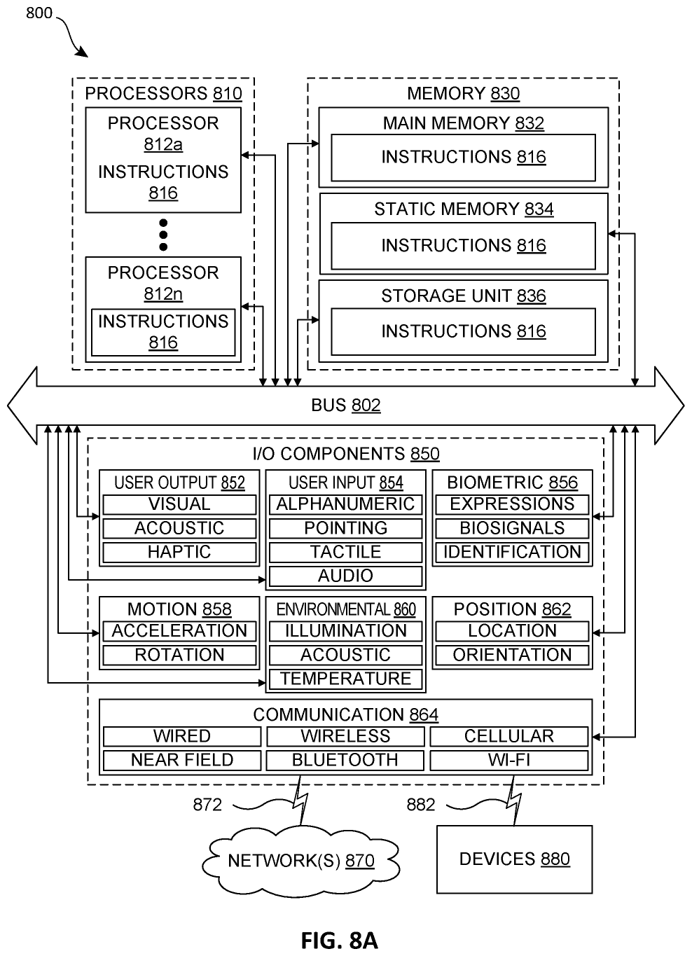

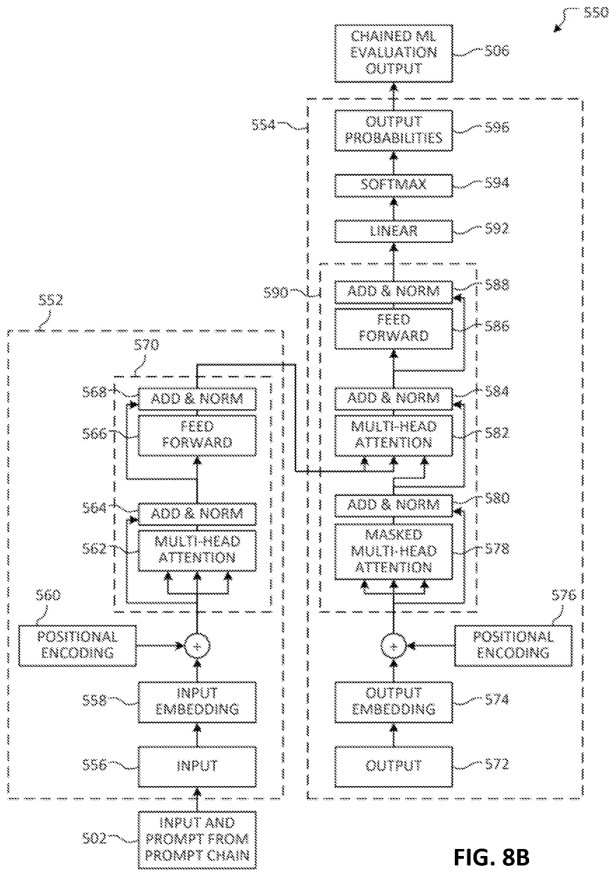

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8A that includes, among other things, processors 810, memory 830, and input/output (I/O) components 850. A representative hardware layer 704 is illustrated and can represent, for example, the machine 800 of FIG. 8A. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8A, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8A is a block diagram illustrating components of an example machine 800 configured to read instructions from a machine-readable medium (for example, a machine-readable storage medium) and perform any of the features described herein. The example machine 800 is in the form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8A shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8A are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

FIG. 8B is a block diagram depicting an example architecture 550 for a generative Artificial Intelligence (GAI) as used in the examples and techniques described herein. As shown in FIG. 8B, the encoder 552 is responsible for processing input data and generating meaningful representations. The encoder 552 incorporates a prompt chain 502, which serves as a guiding source for context. The input data, represented by input 556, undergoes a transformation in the input embedding 558 to create a numerical representation suitable for processing. To capture the sequential order of the input, positional encoding 560 is added to the input embedding.

Multi-head attention operator 562, within the encoder 552, concurrently focuses on different aspects of the input. The multi-head attention operation 562 is followed by the add & norm operation 564, which normalizes and combines the multi-head attention outputs with the input embedding. Further processing involves the feed forward operation 566 and the subsequent add & norm operation 568 that normalizes and combines the output of the feed-forward operation with previous results.

The decoder 554 is responsible for generating the final output. The output sequence is represented by output 57), and its numerical representation is obtained through output embedding 574. Similar to the encoder 552, in the decoder 554, positional encoding 576 is added to the output embedding to provide positional information.

Also within the decoder 554, the masked multi-head attention operation 578 prevents information leakage from future positions. This is followed by another add & norm operation 580, which normalizes and combines the output with the output embedding. Multi-head attention operator 582 in the decoder 554 focuses on the relationship between the output and input sequences, and the subsequent add & norm operation 584 normalizes and combines the output with previous results.

The processing in the decoder 554 continues with the feed forward operation 586, add & norm operation 588, linear transformation 592, Softmax operation 594 for probability distribution calculation, and finally, the output probabilities operation 596 representing the probabilities assigned to each element in the output sequence. The Chained ML Evaluation Output 506 is the final output of the language model, incorporating both encoder and decoder results. This output is generated based on the interactions and dependencies between the input and output sequences, providing a comprehensive representation of the language model's prediction.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory comprising programming instructions for execution by the processor alone or in combination with other processors, to implement a service to generate a work as specified by a user;
wherein the service comprises:
a service-side component of a User Interface (UI) to receive user input about the work from the user, the user input including an initial prospective description of the work that the user intends to generate using the system and a set of parameters for the work;
a prompt generator to generate prompts for a Generative Artificial Intelligence (GAI) based on the user input to generate both an outline for the work and a proposed version of the work, the prompt generator further to generate additional prompts to the AI to update either the outline or the proposed version of the work based a user editing of the other of the outline or the proposed version of the work so that the proposed version of the work and the outline are synchronized as the user interacts with either the proposed version of the work or the outline; and
an Application Programming Interface to deliver prompts to the GAI and receive responses from the GAI for presentation in the UI.

2. The system of claim 1, wherein, in response to user input specifying the description of the work, the prompt generator is to generate a first prompt to the GAI instructing the GAI to generate a list of the parameters for the work based on the description and options for each parameter.

3. The system of claim 2, wherein the UI is to display the parameters generated by the GAI, with corresponding options, and receive user input selecting an option for each of the parameters.

4. The system of claim 1, wherein the UI comprises controls for a number of the parameters for the work, each parameter having multiple corresponding options selectable by the user as a setting for the corresponding parameter.

5. The system of claim 4, wherein the multiple corresponding options for each parameter include a customizable option in which the user can enter a setting for that parameter that is not among the corresponding options for that parameter.

6. The system of claim 4, wherein the UI comprises a number of drop-down menus, each menu corresponding to one of the parameters and including the corresponding options.

7. The system of claim 4, wherein, in response to user input selecting options for the parameters, the prompt generator is to generate an outline prompt to the GAI instructing the GAI to generate the outline for the work based on the description and the options selected for each of the parameters.

8. The system of claim 7, wherein, in response to user input changing selection of an option for a parameter, the prompt generator is to generate another outline prompt to the GAI instructing the GAI to update the outline based on the changed option selection.

9. The system of claim 7, wherein:
the outline prompt instructs the GAI to divide the outline into sections; and
the UI is to accept user edits to the outline.

10. The system of claim 7, wherein the prompt generator is to generate a work prompt to the GAI instructing the GAI to generate a proposed version of the work based on the outline.

11. The system of claim 10, wherein the work prompt further specifies that the proposed version of the work is to be based on the description and parameter options selected by the user.

12. The system of claim 10, wherein the UI is to present the outline and the proposed version of the work in a side-by-side arrangement and to accept user editing to either of the outline or proposed version of the work, wherein the outline and the proposed version of the work are synchronized in real-time as user editing occurs to either.

13. The system of claim 1, wherein the parameters include at least one of tone, voice, audience and output type.

14. The system of claim 1, wherein the user input editing either the outline or the proposed version of the work is reformatting of text in either the outline or the proposed version of the work, the prompt generator to interpret the reformatting of the text into an instruction to the GAI in the prompt regarding the text reformatted.

15. The system of claim 13, further comprising a log storing a record of the user input editing either the outline or the proposed version of the work, wherein subsequent prompts to the GAI include information from the log on previous user input.

16. A device comprising:
a processor, and
a memory storing executable instructions which, when executed by the processor alone or in combination with other processors, causes the processor, alone or in combination with other processors, to perform the following functions:
with a User Interface (UI), receive user input about a work from the user, the user input including an initial prospective description of the work that the user intends to generate using the device and a set of parameters for the work; and
with a prompt generator, generate prompts for a Large Language Model (LLM) based on the user input to generate both an outline for the work and a proposed version of the work, the prompt generator further to generate additional prompts to the LLM to update either the outline or the proposed version of the work based a user editing of the other of the outline or the proposed version of the work.

17. The device of claim 16, wherein the UI comprises controls for the parameters for the work, each parameter having multiple corresponding options selectable by the user as a setting for the corresponding parameter.

18. The device of claim 17, the instructions further causing the processor to, in response to user input selecting options for the parameters, operate the prompt generator to generate a prompt to the LLM instructing the LLM to generate an outline for the work based on the description and the options selected for each of the parameters.

19. The device of claim 18, the instructions further causing the processor to operate the prompt generator to generate another prompt to the LLM instructing the LLM to generate a proposed version of the work based on the outline.

20. A method of generating a work for a user, the method comprising:
receiving, via a User Interface (UI), a description from a user describing the work that the user wants to generate;
receiving, via the UI, user input selecting a setting from among multiple options for each of a number of parameters for the work;
generating, via a prompt generator, a prompt to a Large Language Model (LLM), the prompt instructing the LLM to generate an outline for the work based on the description and the options selected for each of the parameters;
generating, via the prompt generator, another prompt to the LLM instructing the LLM to generate a proposed version of the work based on the outline;
receiving, via the UI, user edits to either the outline or the proposed version of the work; and
in response to user edits to either the outline or the proposed version of the work, generating, via the prompt generator, an additional prompt to the LLM instructing the LLM to revise the other of the outline or proposed version of the work based on the user edits.
